(19) United States
(12) Patent Application Publication
(10) Pub. No.: US 2026/0133817 A1
(43) Pub. Date: May 14, 2026

(54) NETWORK-BASED VIRTUAL MACHINE REPLICATION

(71) Applicant: Hewlett Packard Enterprise Development LP, Spring, TX (US)

(72) Inventors: Omer Uretzky, Herzliya (IL); Gil Barash, Herzliya (IL); Roi Romy, Herzliya (IL)

(21) Appl. No.: 18/943,164

(22) Filed: Nov. 11, 2024

(51) Int. Cl. G06F 9/455

(52) U.S. Cl. CPC G06F 9/45558; G06F 2009/4557; G06F 2009/45595

(57) ABSTRACT

A method and system for replicating data change operations in a virtualized environment is provided. A data change filter in a hypervisor of a virtualization host intercepts data change operations from a virtual machine. A network connection is established between the data change filter and a replication processing service executing on a separate replication host. The replication processing service receives the data change operations from the data change filter over the network connection and replicates the data change operations to a backup site.

### BACKGROUND

Virtualization technology allows multiple virtual machines to execute on a single physical host, improving resource utilization and flexibility in computing environments. These virtual machines function as independent systems, each with its own operating system and applications. By abstracting the hardware resources of a physical machine, virtualization enables the creation of multiple isolated virtual environments on a single physical server. This technology has revolutionized data centers and cloud computing, allowing for more efficient use of computing resources and greater scalability.

The concept of virtualization has gained significant traction in recent years due to advances in hardware and software capabilities. Modern virtualization platforms use a hypervisor, also known as a virtual machine monitor, to manage the allocation of physical resources to virtual machines. This layer of abstraction allows multiple operating systems and applications to share the same physical hardware without interfering with each other. Virtualization can be applied to various components of IT infrastructure, including servers, storage, and networks, providing a foundation for flexible computing environments.

Virtualization offers numerous benefits to organizations, including reduced hardware costs, improved energy efficiency, and simplified IT management. It enables rapid provisioning of new virtual machines, facilitates easier testing and development environments, and supports legacy applications on modern hardware. Additionally, virtualization enhances business continuity by allowing for easier migration of virtual machines between physical hosts. In a virtualized infrastructure, data backup and disaster recovery are important to protect against data loss and system failures.

### BRIEF DESCRIPTION OF THE DRAWINGS

For a more complete understanding of this disclosure, and advantages thereof, reference is now made to the following descriptions taken in conjunction with the accompanying drawings.

FIG. 1 is a block diagram of a virtualized environment, according to some implementations.

FIGS. 2A-2C illustrate various configurations of a virtualization backup system during a replication process, according to some implementations.

FIG. 3 is a flow diagram of a replication method, according to some implementations.

FIGS. 4A-4B are block diagrams of intermediate steps in a failover process, according to some implementations.

FIGS. 5A-5B are block diagrams of intermediate steps in a failover process, according to some other implementations.

Corresponding numerals and symbols in the different figures generally refer to corresponding parts unless otherwise indicated.

### DETAILED DESCRIPTION

The following disclosure provides many different examples for implementing different features. Specific examples of components and arrangements are described below to simplify the present disclosure. These are, of course, merely examples and are not intended to be limiting.

Backup systems for virtualized environments often replicate virtual machines from one location to another for disaster recovery purposes. In one example, a backup system replicates a virtual machine by continuously capturing the data change operations made to the virtual machine and sending those data change operations to a backup site. Data change operations can be captured with a filter, which operates in the hypervisor of the virtualization host. This filter, also referred to as a data change filter, is a software component of the hypervisor that intercepts and copies the modifications made to the virtual machine’s data. For example, the data change operations may be I/O operations, and the data change filter may be an input/output (I/O) filter that intercepts the I/O operations from the protected virtual machine. By operating within the hypervisor, the filter may capture data change operations with low impact on the virtual machine’s performance. A replication processing service obtains the captured data change operations from the filter and handles the replication of those captured data change operations to the backup site. The data change operations may be received from the filter via any suitable communication channel, such as a network. A replication management service oversees the backup system, including the configuration and coordination of the data change filter and replication processing service.

This disclosure describes a backup system that separates the replication processing service from the virtualization host where the data change filter is installed. This separation allows for more flexible deployment options and improved resource utilization. A replication processing service is installed on a dedicated replication host, which may be physical or virtual. Furthermore, a single replication processing service may manage multiple data change filters across different virtualization hosts, without each virtualization host needing a dedicated replication processing service.

The backup system utilizes a network connection, such as one based on TCP/IP, between the data change filter and the replication processing service, allowing them to operate on separate hosts. This network-based communication enables various deployment scenarios, such as having multiple data change filters on different virtualization hosts sending data to a single replication processing service or allowing failover virtual machines to move between hosts while maintaining replication.

One benefit of this separation is the ability to optimize resource usage in disaster recovery scenarios. For example, in a standby configuration, a single, high-capacity replication processing service can be ready to manage multiple virtualization hosts. In this case, during a failover event, standby hosts can be powered on, and the data change filters on these hosts can communicate with the centralized replication processing service over the network to perform data restoration. This configuration allows for simplified management and potentially reduced resource overhead compared to having individual replication processing services on each host.

Another deployment scenario is the ability to have a single active virtualization host run multiple replication processing services, each corresponding to a powered-off standby host. During a failover event, standby hosts can be powered on, and their respective replication processing services can be quickly moved to them. This approach allows for efficient use of resources during normal operations while providing rapid failover capabilities when needed.

By separating the replication processing service from the data change filter and providing network-based communication between them, the backup system provides greater flexibility in deployment options and improved resource utilization, particularly in disaster recovery scenarios.

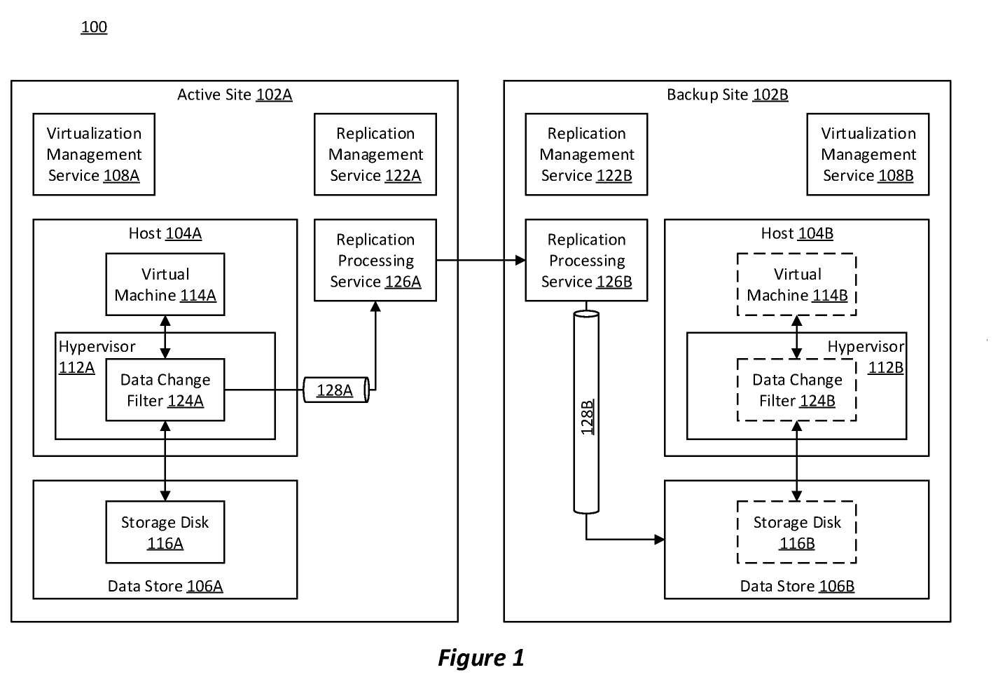

FIG. 1 is a block diagram of a virtualized environment 100, according to some implementations. The virtualized environment 100 includes multiple sites 102, including an active site 102A and a backup site 102B. In some aspects, replication is utilized to create and maintain backup copies of data and systems from the active site 102A to the backup site 102B. This configuration provides data protection and disaster recovery capabilities, allowing for operational continuity at the backup site 102B in case of failures at the active site 102A.

The active site 102A serves as the primary operational environment within the virtualized environment 100. It includes various components that work together to support the execution of virtual machines, including a host 104A, a data store 106A, and a virtualization management service 108A. While only one instance of each component is shown, there may be multiple instances of each component.

The host 104A may be a physical server that provides the computational resources necessary to run virtual machines. Thus, the host 104A may be referred to as a virtualization host. It executes a hypervisor 112A that manages the allocation of hardware resources to a virtual machine 114A running on the host 104A. The host 104A may also include various components to support virtualization and system management. In some aspects, the host 104A may incorporate hardware-assisted virtualization technologies, such as Intel VT-x or AMD-V, to improve performance and security of the virtual machine 114A. The host 104A may be equipped with a high-performance processor, ample memory, and fast storage interfaces to efficiently execute multiple virtual machines concurrently. Additionally, the host 104A may feature a network interface with support for advanced capabilities like Single Root I/O Virtualization (SR-IOV) to provide dedicated network resources to the virtual machine 114A. In some cases, the host 104A may also include specialized hardware accelerators for tasks such as encryption or graphics processing, which can be shared among virtual machines to enhance their capabilities. The host 104A may support live migration capabilities, allowing virtual machines to be moved between physical hosts with minimal downtime. It may also implement resource pools and distributed resource scheduling to optimize workload distribution across multiple hosts in a cluster.

The data store 106A is a storage system that provides the underlying storage infrastructure for the host 104A. It may include one or more storage devices, such as hard disk drives, solid-state drives, storage area networks, or the like. The data store 106A may contain virtual machine disk files, configuration files, and other data necessary for the operation of the virtual machine 114A running on the host 104A. For example, the data store 106A may include a storage disk 116A (which may be a physical or virtual disk) for the virtual machine 114A. In some aspects, the data store 106A utilizes advanced storage technologies like thin provisioning or deduplication to optimize storage utilization. It may also implement tiered storage architectures, where frequently accessed data is stored on high-performance media while less frequently accessed data is moved to lower-cost storage tiers. The data store 106A may support various storage protocols, such as Network File System (NFS), Internet Small Computer System Interface (iSCSI), or Fibre Channel, to provide flexible connectivity options for the host 104A. In some cases, the data store 106A incorporates features like data compression or encryption to enhance data security and reduce storage footprint. The data store 106A may support capabilities that allow virtual machine disks to be migrated between different storage systems without interrupting the running virtual machines. It may also implement storage policies to automate the placement and management of virtual machine data based on performance, availability, and compliance requirements.

The virtualization management service 108A is responsible for overseeing and controlling the virtualized environment on the active site 102A. It provides a centralized interface for managing the host 104A (including the virtual machine 114A) and the data store 106A (including the storage disk 116A). The virtualization management service 108A may handle tasks such as virtual machine provisioning, resource allocation, monitoring, and maintenance. It may also offer capabilities for creating and managing virtual networks, configuring storage policies, and implementing security measures across the virtualized infrastructure. In some aspects, the virtualization management service 108A provides features for performance optimization, capacity planning, and automated workload balancing among hosts. Additionally, the virtualization management service 108A may offer APIs and plugins to extend its functionality and integrate with third-party management tools.

The virtualization management service 108A may be implemented in any desired manner to suit the needs of the virtualized environment 100. The virtualization management service 108A may be deployed on a physical host, as a virtual machine on a host, using containerization technologies, or the like. More generally, the virtualization management service 108A may be executed on a management host (not separately illustrated in FIG. 1), which may be a physical or virtual host.

The active site 102A incorporates a backup system to ensure data protection and disaster recovery capabilities. This system utilizes replication, which continuously captures and transmits data change operations from the active site 102A to the backup site 102B. The backup site 102B may be different from the active site 102A. Specifically, the sites may be at different physical locations (e.g., different geographic locations) or different logical locations (e.g., different parts of a network). By replicating data in near real-time, the backup system may maintain an up-to-date copy of information at the backup site 102B, allowing for rapid recovery in case of failures at the active site 102A. The backup system includes a replication management service 122A, a data change filter 124A, and a replication processing service 126A at the active site 102A, which work together to replicate data change operations to the backup site 102B.

The replication management service 122A oversees the replication process within the active site 102A. It configures, coordinates, and monitors the various components involved in data replication. The replication management service 122A may interact with the virtualization management service 108A to manage protection of the virtual machine 114A and to gather necessary configuration details. It also manages the deployment and configuration of replication components in the active site 102A.

The replication management service 122A may be implemented in any desired manner to suit the needs of the virtualized environment 100. The replication management service 122A may be deployed on a physical host, as a virtual machine on a host, using containerization technologies, or the like. More generally, the replication management service 122A may be executed on a management host (not separately illustrated in FIG. 1), which may be a physical or virtual host.

The data change filter 124A is a specialized component installed in the hypervisor 112A of the host 104A. In some aspects, a data change filter is installed within the hypervisor of each host for which replication is desired. Its primary function is to intercept and capture data change operations from the virtual machine 114A running on the host 104A. A data change operation may include any modification to data stored on or accessed by the virtual machine 114A, such as write operations. A data change operation may include an I/O operation for the storage disk 116A, which may be file-agnostic as it operates at the block level of storage. In some implementations, a data change operation may include an offset (of the storage disk 116A) and binary data. Thus, the data change filter 124A operates at a low level (e.g., closer to the storage disk 116A than applications accessing the storage disk 116A), intercepting data change operations from the virtual machine 114A before they reach the corresponding storage disk 116A. In some implementations, the filter intercepts these operations asynchronously, allowing the original data change operation to proceed to the storage disk 116A without blocking or delaying it. This asynchronous interception enables the filter to capture data change operations without impacting the performance of the virtual machine 114A. The data change operations will be subsequently replicated to the backup site 102B. Continuously capturing and replicating these data change operations may allow for nearly real-time data protection, with only a minimal delay between when changes occur on the protected virtual machine 114A and when they are replicated to the backup site 102B.

The data change filter 124A is integrated into the I/O stack of the hypervisor 112A, functioning as a virtual I/O adapter that intercepts and captures data change operations from a virtual machine 114A at the block level. It may utilize networking communications (e.g., a TCP/IP-based communication protocol) to transmit captured data change operations to services that are external to the hypervisor 112A, working asynchronously to capture I/O operations without significantly impacting the performance of the virtual machine 114A. The data change filter 124A intercepts write operations, including storage offset and binary data information, on the way to the virtual machine's storage disk. In some implementations, it includes capabilities for data compression, batching, ensuring data integrity, and/or managing operation sequencing to maintain consistency in replicated data. The data change filter 124A runs in the user space of the hypervisor 112A instead of its kernel space, which may improve stability of the host 104A. This user space implementation may allow for easier updates and maintenance of the data change filter 124A without requiring changes to the core components of the hypervisor 112A.

The replication processing service 126A is responsible for processing and transmitting the data change operations captured from the virtual machine 114A to the backup site 102B. It may receive data change operations from the data change filter 124A, potentially across hosts. The replication processing service 126A may perform various tasks such as data compression, deduplication, and encryption before transmitting the changes over a network to the backup site 102B. It may also manage the sequencing and integrity of the replicated data to ensure consistency at the backup site 102B. In some aspects, the replication processing service 126A implements intelligent batching algorithms to optimize network usage and reduce latency. That is, the replication processing service 126A may aggregate the data change operations from the data change filter 124A and then batch them for sending to the backup site 102B, potentially at a configurable interval. For example, the replication processing service 126A may batch data change operations for 5 seconds before transmitting them to the backup site 102B. This allows administrators to configure a balance between replication frequency and network efficiency based on their specific requirements and network conditions. In some aspects, the replication processing service 126A replicates the data change operations without aggregation, which may allow for faster replication.

The replication processing service 126A may be implemented in any desired manner to suit the needs of the virtualized environment 100. The replication processing service 126A may be deployed on a physical host, as a virtual machine on a host, as a Virtual Replication Appliance (VRA) on a host, using containerization technologies, or the like. More generally, the replication processing service 126A may be executed on a replication host (not separately illustrated in FIG. 1), which may be a physical or virtual host.

The components of the active site 102A (including the host 104A and associated services) may be interconnected over any suitable type of network, including a local area network (LAN), a wide area network (WAN), the internet, a high-speed interconnect like InfiniBand, or the like. In some implementations, these network connections may utilize dedicated high-speed links between components to ensure low-latency and high-bandwidth communication for efficient data replication. The network infrastructure may include routers, switches, and firewalls configured to prioritize and secure the traffic between the data change filter 124A and the replication processing service 126A. The network infrastructure may also include virtual networking components provided by the hypervisor 112A. The network may support quality of service (QoS) mechanisms to prioritize or deprioritize replication traffic based on replication requirements and network conditions. In some cases, the network may leverage specialized protocols or optimizations designed for low-latency, high-throughput data transfer between components in the virtualized environment 100.

The replication processing service 126A is separate from the data change filter 124A. This separation allows for flexible deployment options and improved resource utilization. The replication processing service 126A may be executed on a dedicated replication host, which may be physical or virtual. The data change filter 124A and the replication processing service 126A may communicate over the network of the active site 102A, enabling them to operate on separate hosts. This network-based communication allows for various deployment scenarios, such as having multiple data change filters 124A on different virtualization hosts sending data to a replication processing service 126A on a single replication host. In some implementations, the replication processing service 126A replicates changes from multiple data change filters 124A to the backup site 102B.

The data change filter 124A may be connected to the replication processing service 126A through a network connection 128A, which may be a connection in the network of the active site 102A. This network connection 128A allows the data change filter 124A to transmit intercepted data change operations to the replication processing service 126A for processing and replication. Due to the network connection 128A, there is separation between the virtual machine 114A and the replication processing service 126A, with the data change filter 124A acting as an intermediary for data replication across the virtualization and replication hosts. As a result, the replication processing service 126A may run on a different host than the data change filter 124A.

The network connection 128A between the data change filter 124A and the replication processing service 126A may utilize a TCP/IP-based protocol optimized for low-latency, high-throughput data transfer. This protocol may implement a custom application layer designed specifically for efficient transmission of data change operations. The protocol may include features such as message framing, sequence numbering, and acknowledgment mechanisms to ensure reliable delivery of data change operations to the replication processing service 126A. Additionally, the protocol may support delta encoding, where only the differences between consecutive operations are transmitted, further reducing the amount of data sent over the network. The protocol may support connection pooling, allowing multiple logical streams of data change operations to be multiplexed over a single connection.

The network connection 128A may employ data compression techniques to reduce bandwidth usage. For example, the data change filter 124A may apply lossless compression algorithms such as LZ4 or Zstandard to the intercepted data change operations before transmission to the replication processing service 126A. The compression level may be configurable, and may be set by an administrator based on the desired compression efficiency and processing overhead.

The network connection 128A may employ security measures to protect the transmitted data. This may include using Transport Layer Security (TLS) for encryption and authentication, potentially using hardware-accelerated encryption on supported platforms. The protocol may implement a handshake process that includes mutual authentication between the data change filter 124A and the replication processing service 126A, potentially using pre-shared certificates. This authentication process may utilize public/private certificate pairs, such as certificate pairs that are generated by a service or system administrator. The use of these certificate pairs may allow for verifying the identity of both the sender and receiver of data change operations.

The aforementioned hosts (e.g., virtualization hosts, replication hosts, and management hosts) may include suitable components for performing any desired functionality. One or more modules within the hosts may be partially or wholly embodied as software and/or hardware for performing any functionality described herein. For example, a host may include a processor and a memory. The processor may be a microprocessor, an application-specific integrated circuit, a microcontroller, or the like. The memory may be a non-transitory computer readable medium that stores instructions for execution by the processor. The instructions, when executed by the processor, cause the processor to perform any functionality described herein.

The backup site 102B has similar components to the active site 102A but may be located at a different physical or logical location. It includes a host 104B, a data store 106B, a virtualization management service 108B, a hypervisor 112B, a virtual machine 114B, a storage disk 116B, a replication management service 122B, a data change filter 124B, a replication processing service 126B, and a network connection 128B, which may have similar functionality and be implemented in a similar manner as their counterparts at the active site 102A. While only one instance of each component is shown, there may be multiple instances of each component.

The backup site 102B is primarily used for replication and failover purposes, serving as a destination for data backed up from the active site 102A. In some cases, the backup site 102B remains in a standby state during normal operations, ready to take over in case of failures or disasters at the active site. The replication process between the active site 102A and the backup site 102B is managed by the replication management services 122A, 122B.

The replication processing service 126B is separate from the data change filter 124B. This separation allows for flexible failover operations, such as having multiple data change filters 124B on different virtualization hosts be managed by a replication processing service 126B on a single replication host.

In a replication flow for a virtual machine 114A, the data change filter 124A intercepts data change operations made by the virtual machine 114A to its storage disk 116A. These intercepted data change operations are then sent, by the data change filter 124A, to the replication processing service 126A. The replication processing service 126A processes the data change operations, replicating them to the corresponding replication processing service 126B at the backup site 102B. For example, the data change operations may be sent from the replication processing service 126A to the replication processing service 126B over a network connection. Upon receiving the replicated data change operations, the replication processing service 126B stores them in a journal, which may be located on the data store 106B at the backup site 102B. This journaling approach may allow for point-in-time recovery and provides a detailed record of all data change operations from the storage disk 116A, potentially enabling more granular restore options.

In a failover flow for a virtual machine 114A, the backup site 102B takes over operations from the active site 102A. The replication processing service 126B accesses the journal stored on the data store 106B to recover the data for the virtual machine 114A to a desired point in time. The recovered data is used to recreate a storage disk 116B in the data store 106B. A new virtual machine 114B is created on the host 104B at the backup site 102B, along with a corresponding data change filter 124B. This new virtual machine 114B is configured to use the recreated storage disk 116B, effectively becoming a replica of the original virtual machine 114A.

In some aspects, the storage disk 116B may be initially created as an empty disk so the virtual machine 114B may begin running quickly. Before the storage disk 116B is filled with restored data, the data change filter 124B may fetch needed data for the virtual machine 114B. Specifically, the data change filter 124B may forward a request for data from the virtual machine 114B to the replication processing service 126B, which may fetch the requested data from the journal and provide it to the data change filter 124B. Once the new virtual machine 114B is operational, the data change filter 124B captures new data change operations to the storage disk 116B. These new data change operations may be sent to the replication processing service 126B for further replication. The data change filter 124B may capture the new data change operations asynchronously or synchronously, depending on whether the storage disk 116B has been rebuilt. In some implementations, the data change filter 124B may capture the new data change operations synchronously during rebuilding of the storage disk 116B, temporarily blocking operations from proceeding to the storage disk 116B until relevant data of the storage disk 116B has been retrieved from the journal.

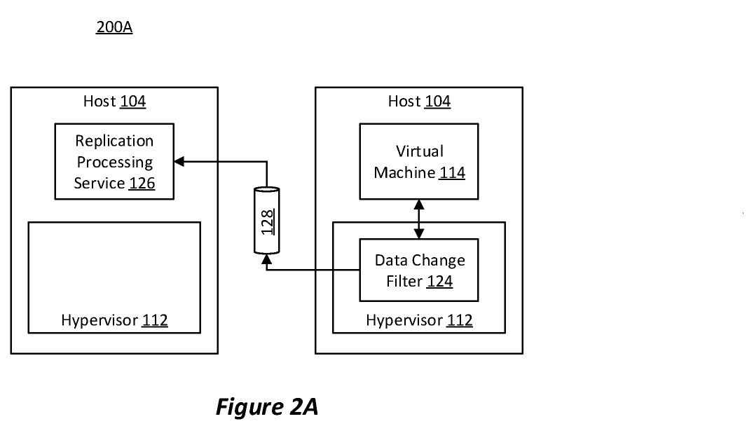

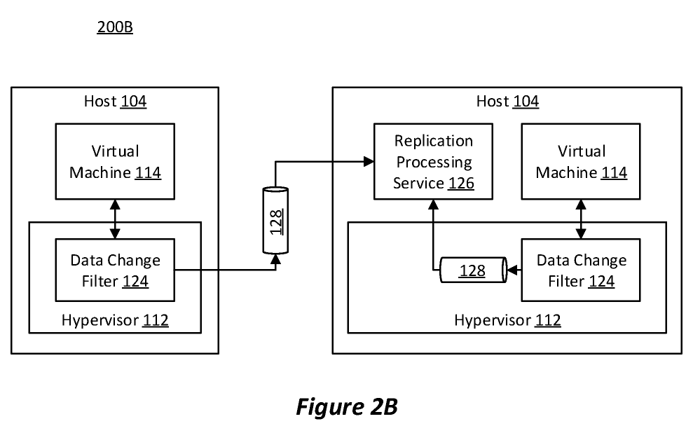

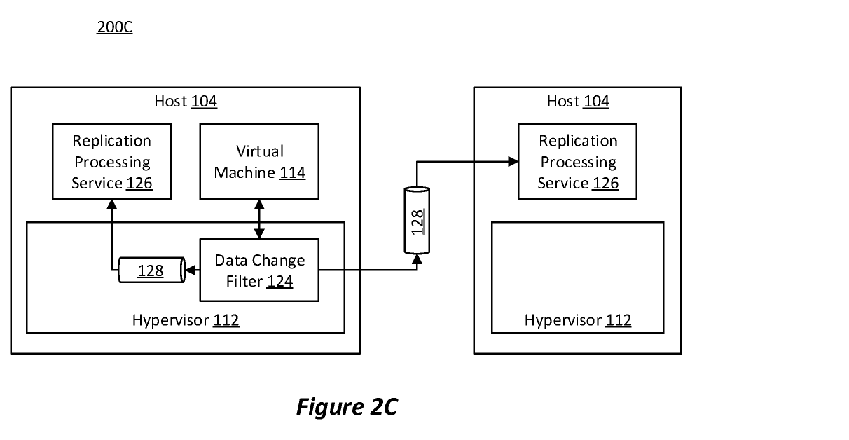

FIGS. 2A-2C illustrate various configurations of a virtualization backup system during a replication process, according to some implementations. In these configurations, replication processing services 126 and data change filters 124 are deployed on various hosts 104. As subsequently described, a replication processing service 126 may be deployed on the same host 104 as a virtual machine 114 that will be backed up by the replication processing service 126, or a virtual machine 114 and a replication processing service 126 may be deployed on separate hosts.

FIG. 2A shows one multi-host configuration 200A of the backup system. In this configuration, two hosts 104 are depicted, each running a hypervisor 112. A first host 104 executes a replication processing service 126 on its hypervisor 112. A second host 104 executes a virtual machine 114 on its hypervisor 112, which also includes a data change filter 124. As a result, the replication processing service 126 runs on a different host 104 than the data change filter 124.

The virtual machine 114 is connected to the data change filter 124 within the same host. The data change filter 124 intercepts data change operations from the virtual machine 114. The data change filter 124 is connected to the replication processing service 126 through a network connection 128, as previously described.

By separating the replication processing service 126 from the data change filter 124, the system allows for more efficient use of resources and enhanced load balancing capabilities. In some aspects (subsequently described for FIG. 2B), a single replication processing service 126 may replicate data change operations from multiple data change filters 124 of virtual machines 114 on different hosts 104. In some aspects (subsequently described for FIG. 2C), multiple replication processing services 126 may work together in a load-balanced manner to distribute the replication workload from a data change filter 124.

FIG. 2B shows another multi-host configuration 200B of the backup system. In this configuration, a replication processing service 126 executing on a single host 104 receives data change operations from multiple data change filters 124 executing on multiple hosts 104. Similar to the configuration 200A, the data change filters 124 intercept data change operations from their respective virtual machines 114 and transmit these operations to the replication processing service 126 over network connections 128. The network connections 128 may include a network connection 128 between hosts 104 or a network connection 128 within a same host 104 (e.g., provided by the hypervisor 112 of that host 104).

The data change filters 124 may be located on the same host 104 as the replication processing service 126 or on a different host 104. This arrangement allows the replication processing service 126 to centralize the processing of data change operations from multiple virtual machines 114 across different hosts 104, which may reduce overall resource requirements compared to having a dedicated replication processing service on each host 104. This approach may be beneficial for organizations with virtualization licenses based on the CPU usage of powered-on hosts.

FIG. 2C shows another multi-host configuration 200C of the backup system. In this configuration, multiple replication processing services 126 executing on multiple hosts 104 receive data change operations from a single data change filter 124 executing on a single host 104. Similar to the configuration 200A, the data change filter 124 intercepts data change operations from its respective virtual machine 114 and transmits these operations to the replication processing services 126 over network connections 128. The network connections 128 may include a network connection 128 between hosts 104 or a network connection 128 within a same host 104 (e.g., provided by the hypervisor 112 of that host 104).

The replication processing services 126 may be located on the same host 104 as the data change filter 124 or on a different host 104. This arrangement allows for distributed replication of data change operations from a single virtual machine 114, which may improve system resilience and/or performance compared to having a dedicated replication processing service on each host 104. Furthermore, the separation facilitates dynamic load balancing of replication processing services 126. The data change filter 124 may reroute its data change operations to different replication processing services 126 regardless of their host locations, allowing for balanced workload distribution across the available replication processing services 126. This flexibility in load balancing may contribute to more efficient resource utilization and improved overall system performance.

The configurations illustrated in FIGS. 2B and 2C may be combined to create additional deployment scenarios. In such configurations, the backup system may incorporate any number of data change filters 124 and any number of replication processing services 126, with data change operations being replicated in any desired manner. For example, multiple data change filters 124 from various hosts 104 may send data change operations to multiple replication processing services 126 distributed across different hosts 104. This arrangement may allow for dynamic load balancing and fault tolerance, as the system can redistribute the replication workload based on current resource availability and performance metrics. The system may support many-to-many replication, where a data change filter 124 sends data change operations to multiple replication processing services 126, and a replication processing service 126 receives data change operations from multiple data change filters 124. This flexibility in configuration may allow organizations to tailor their replication scheme to specific performance, scalability, and redundancy requirements.

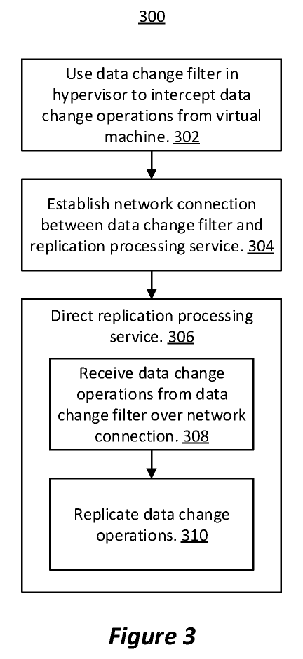

FIG. 3 is a flow diagram of a replication method 300, according to some implementations. The replication method 300 will be described in conjunction with the virtualized environment 100 of FIG. 1. The replication method 300 may be implemented by a management service. Specifically, the replication management service 122A may perform the replication method 300.

The replication management service 122A may perform a step 302 of using a data change filter 124A in a hypervisor of a virtualization host 104A. The hypervisor is configured to execute a virtual machine 114A, while the data change filter 124A is configured to intercept data change operations from the virtual machine 114A. The data change operations may include input/output operations for a virtual storage disk 116A, and each of the input/output operations may include an offset of the virtual storage disk 116A and binary data. In some cases, the data change filter 124A may intercept the data change operations by asynchronously copying the input/output operations without blocking the input/output operations from proceeding to the virtual storage disk 116A.

The replication management service 122A may perform a step 304 of establishing a network connection 128A between the data change filter 124A and a replication processing service 126A. The replication processing service 126A may execute on a replication host, with the replication host being different from the virtualization host 104A. The replication host may be virtual or physical. The replication host and the virtualization host 104A are located at an active site 102A. The network connection 128A may be established using a TCP/IP-based protocol.

The replication management service 122A may perform a step 306 of directing the replication processing service 126A to perform subsequent operations. This step may involve managing the replication processing service 126A such as configuring it to execute specific tasks related to data replication.

The replication management service 122A may perform a step 308 of directing the replication processing service 126A to receive the data change operations from the data change filter 124A over the network connection 128A. The data change operations may be compressed at the data change filter 124A before transmitting the compressed data change operations over the network connection 128A. Additionally or alternatively, the data change operations may be encrypted at the data change filter 124A before transmitting the encrypted data change operations over the network connection 128A.

In some aspects, the data change filter 124A may be one of a plurality of data change filters 124A used in a plurality of hypervisors, and the network connection 128A may be one of a plurality of network connections 128A established between the replication processing service 126A and the data change filters 124A. The replication management service 122A may perform a step of directing the replication processing service 126A to receive respective data change operations from respective ones of the data change filters 124A over the network connections 128A.

In some aspects, the replication processing service 126A may be one of a plurality of replication processing services 126A, and the network connection 128A may be one of a plurality of network connections 128A established between the data change filter 124A and the replication processing services 126A. The replication management service 122A may perform a step of balancing the receiving of the data change operations over the network connections 128A based on a workload distribution of the replication processing services 126A. The workload distribution may be obtained by receiving workload metrics from the replication processing services 126A and using those metrics to derive the current workload distribution.

The replication management service 122A may perform a step 310 of replicating the data change operations to a backup site 102B. In some implementations, the replication processing service 126A may aggregate the data change operations at a configurable interval before replicating the data change operations.

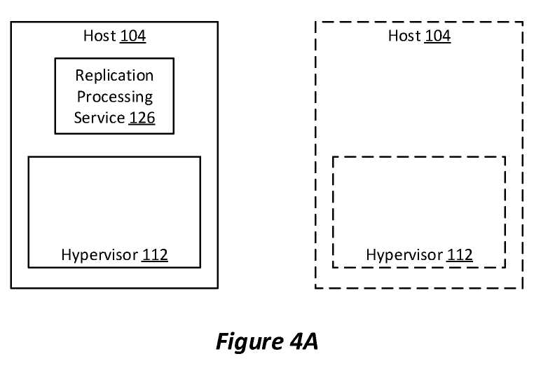

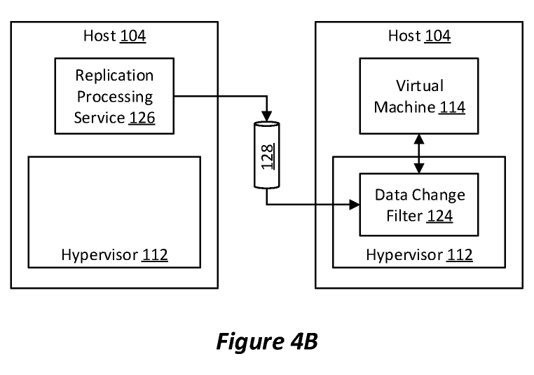

FIGS. 4A-4B are block diagrams of intermediate steps in a failover process, according to some implementations. Specifically, a sequence of configurations at a backup site are shown during failover from an active site. The components at the backup site may be controlled by a replication management service (not separately illustrated).

In FIG. 4A, the backup site is operated in a standby configuration. One host 104 is active and has a replication processing service 126 running on its hypervisor 112. The replication processing service 126 may be responsible for managing replication operations for the backup site. Meanwhile, another host 104 at the backup site is inactive (represented by dashed lines). For example, the inactive host 104 may be on standby, powered off, or the like. In some aspects, the inactive host 104 is powered on but has no virtual machines executing, which may be particularly beneficial for organizations with licensing models based on active CPU usage. During a failover, the inactive host 104 can be rapidly activated and brought into service. This approach allows for quick response to disaster scenarios while minimizing resource consumption during normal operations.

In FIG. 4B, the backup site is switched to a failover configuration. In this configuration, the host 104 that was previously inactive becomes active and starts a virtual machine 114 to execute on its hypervisor 112. A data change filter 124 is configured for the new virtual machine 114. In the failover configuration the data change filter 124 captures data change operations from the virtual machine 114, and also provides needed data to the virtual machine 114.

As previously described, a virtual machine 114 that is started during failover may have its storage disk reconstructed from a replication journal stored on a data store. The reconstruction process may take some time. If the virtual machine 114 calls for data that has not yet been restored to its storage disk, the data change filter 124 may fetch the needed data for the virtual machine 114. Specifically, the data change filter 124 may forward a request for data from the virtual machine 114 to the replication processing service 126, which may fetch the requested data from the replication journal stored on the data store and provide it to the data change filter 124. This allows the virtual machine 114 to begin operating quickly, without waiting for all of its data to be fully restored. Meanwhile, the data change filter 124 continues to capture any new data change operations performed by the virtual machine 114. These captured operations can then be sent to the replication processing service 126 to maintain ongoing replication.

While FIG. 4B illustrates the activation of a single virtual machine 114 during failover, in some implementations, any number of virtual machines may be activated as part of the failover process. In this implementation, a single replication processing service 126 may manage the data change filters 124 for the failover virtual machines 114. This scalable approach allows the backup system to handle various failover scenarios, from single-machine recovery to full-site failover involving multiple virtual machines 114. The replication processing service 126 may coordinate the data restoration and ongoing replication for each activated virtual machine 114.

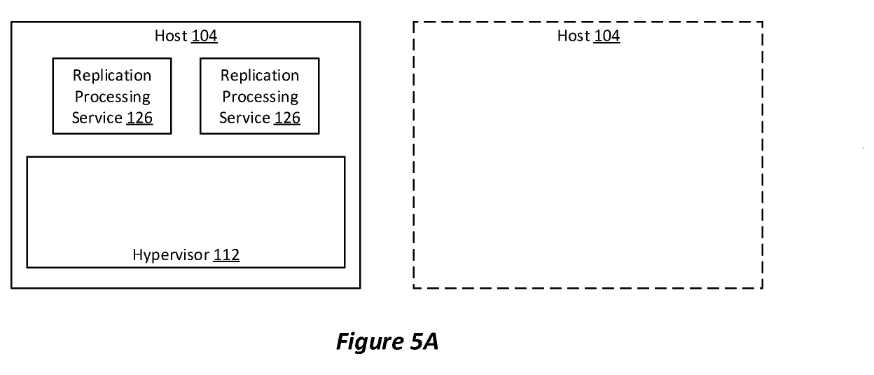

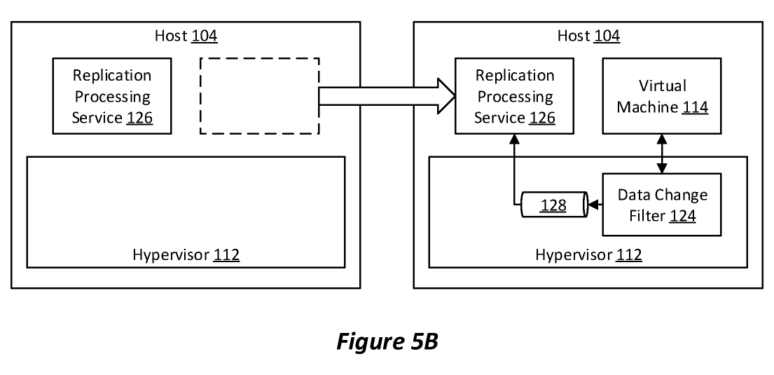

FIGS. 5A-5B are block diagrams of intermediate steps in a failover process, according to some other implementations. Specifically, another sequence of configurations at a backup site are shown during failover from an active site. The components at the backup site may be controlled by a replication management service (not separately illustrated).

In FIG. 5A, the backup site is operated in a standby configuration. In this configuration, one host 104 is active and has multiple replication processing services 126 running on its hypervisor 112. Meanwhile, another host 104 at the backup site is inactive (represented by dashed lines). For example, the inactive host 104 may be on standby, powered off, or the like. In some aspects, the inactive host 104 is powered on but has no virtual machines executing. The replication processing services 126 may be running but idle, and ready to start processing replication data during a failover process. For example, the replication processing services 126 may maintain minimal resource usage, but be configured to quickly initialize and begin processing replication data when activated.

In FIG. 5B, the backup site is switched to a failover configuration. In this configuration, the host 104 that was previously inactive becomes active and starts a virtual machine 114 to execute on its hypervisor 112. A data change filter 124 is configured for the new virtual machine 114. In the failover configuration the data change filter 124 captures data change operations from the virtual machine 114, and also provides needed data to the virtual machine 114. Multiple virtual machines 114 may be activated on different hosts 104 during a failover event, with the virtual machines 114 on each host 104 being managed by a respective replication processing service 126.

In some aspects, the replication processing service 126 for the virtual machines 114 on a newly activated host 104 may be moved to the newly activated host 104. The replication processing service 126 may be moved from the previously running host 104 to the newly activated host 104 using a live migration technique. This technique allows the replication processing service 126 to be transferred between hosts 104 with minimal interruption to its operation. Live migration may involve transferring the memory state and execution context of the replication processing service 126 from one host 104 to another while the replication processing service 126 continues running. Live migration may include reserving necessary resources on the destination host 104, copying memory pages to the destination host 104 while the service continues running, copying CPU state to the destination host 104, and then activating the migrated service on the destination host 104. Throughout this process, a network connection 128 between the data change filter 124 and the replication processing service 126 may be maintained and redirected to the new host 104. The live migration technique may allow for quick activation of failover resources while minimizing downtime.

When the failover event ends, the failover virtual machines 114 may be deactivated, and the replication processing services 126 may be moved back to the original host 104 (as shown in FIG. 5A). This allows some hosts 104 to be deactivated again, returning to a cost-effective standby configuration once the failover event has ended. This approach provides decreased resource usage during normal operations.

In an example implementation of the disclosure, a method includes: using a data change filter in a hypervisor of a virtualization host, the hypervisor configured to execute a virtual machine, the data change filter configured to intercept data change operations from the virtual machine; establishing a network connection between the data change filter and a replication processing service, the replication processing service executing on a replication host, the replication host being different from the virtualization host, the replication host and the virtualization host located at an active site; and directing the replication processing service to: receive the data change operations from the data change filter over the network connection; and replicate the data change operations to a backup site.

In some implementations of the method, the data change filter is one of a plurality of data change filters used in a plurality of hypervisors, the network connection is one of a plurality of network connections established between the replication processing service and the data change filters, and the method further includes directing the replication processing service to receive respective data change operations from respective ones of the data change filters over the network connections. In some implementations of the method, the replication processing service is one of a plurality of replication processing services, the network connection is one of a plurality of network connections established between the data change filter and the replication processing services, and the method further includes balancing the receiving of the data change operations over the network connections based on a workload distribution of the replication processing services. In some implementations of the method, the network connection is established using a TCP/IP-based protocol. In some implementations, the method further includes: compressing the data change operations at the data change filter before transmitting the compressed data change operations over the network connection. In some implementations, the method further includes: encrypting the data change operations at the data change filter before transmitting the encrypted data change operations over the network connection. In some implementations, the method further includes directing the replication processing service to: aggregate the data change operations from the data change filter at a configurable interval before replicating the data change operations. In some implementations of the method, the data change operations include input/output operations for a virtual storage disk, and each of the input/output operations includes an offset of the virtual storage disk and binary data. In some implementations of the method, the data change operations include input/output operations for a virtual storage disk, and the data change filter intercepts the data change operations by asynchronously copying the input/output operations without blocking the input/output operations from proceeding to the virtual storage disk.

In an example implementation of the disclosure, a device includes: a processor; and a non-transitory computer readable medium storing instructions which, when executed by the processor, cause the processor to: configure a data change filter in a hypervisor of a virtualization host, the hypervisor configured to execute a virtual machine, the data change filter configured to intercept data change operations from the virtual machine; and configure a replication processing service on a replication host, the replication host being different from the virtualization host, the replication host and the virtualization host located at an active site, the replication processing service configured to receive the data change operations from the data change filter over a network connection and to replicate the data change operations to a backup site.

In some implementations of the device, the network connection is established using a TCP/IP-based protocol and the data change filter is configured to encrypt and compress the data change operations before sending the data change operations to the replication processing service.

In an example implementation of the disclosure, a system includes: a first replication host located at an active site; and a first virtualization host located at the active site, the first virtualization host being different from the first replication host, the first virtualization host being connected to the first replication host by a first network connection, the first virtualization host configured to: execute a first virtual machine on a first hypervisor; intercept first data change operations from the first virtual machine using a first data change filter of the first hypervisor; and send the first data change operations to the first replication host over the first network connection.

In some implementations, the system further includes: a second replication host located at the active site, the first virtualization host being connected to the second replication host by a second network connection, where the first virtualization host is further configured to intercept second data change operations from the first virtual machine using the first data change filter and send the second data change operations to the second replication host over the second network connection. In some implementations, the system further includes: a second virtualization host located at the active site, the second virtualization host being connected to the first replication host by a second network connection, the second virtualization host configured to: execute a second virtual machine on a second hypervisor; intercept second data change operations from the second virtual machine using a second data change filter of the second hypervisor; and send the second data change operations to the first replication host over the second network connection. In some implementations, the system further includes: a second replication host located at a backup site, the backup site different from the active site, where the first replication host is configured to replicate the first data change operations to the second replication host. In some implementations, the system further includes: a second virtualization host located at the backup site, the second virtualization host being different from the second replication host, the second virtualization host configured to execute a second virtual machine on a second hypervisor, the second replication host configured to rebuild a storage disk for the second virtual machine using the first data change operations. In some implementations of the system, a second data change filter of the second hypervisor is configured to provide data to the second virtual machine while the storage disk is rebuilt. In some implementations, the system further includes: a data store located at the backup site, where the second replication host is configured to journal the first data change operations on the data store. In some implementations of the system, the first virtualization host is further configured to compress the first data change operations before sending the first data change operations to the first replication host over the first network connection. In some implementations of the system, the first virtualization host is further configured to encrypt the first data change operations before sending the first data change operations to the first replication host over the first network connection.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A method comprising:
using a data change filter in a hypervisor of a virtualization host, the hypervisor configured to execute a virtual machine, the data change filter configured to intercept data change operations from the virtual machine;
establishing a network connection between the data change filter and a replication processing service, the replication processing service executing on a replication host, the replication host being different from the virtualization host, the replication host and the virtualization host located at an active site; and
directing the replication processing service to:
receive the data change operations from the data change filter over the network connection; and
replicate the data change operations to a backup site.

2. The method of claim 1, wherein the data change filter is one of a plurality of data change filters used in a plurality of hypervisors, the network connection is one of a plurality of network connections established between the replication processing service and the data change filters, and the method further comprises directing the replication processing service to receive respective data change operations from respective ones of the data change filters over the network connections.

3. The method of claim 1, wherein the replication processing service is one of a plurality of replication processing services, the network connection is one of a plurality of network connections established between the data change filter and the replication processing services, and the method further comprises balancing the receiving of the data change operations over the network connections based on a workload distribution of the replication processing services.

4. The method of claim 1, wherein the network connection is established using a TCP/IP-based protocol.

5. The method of claim 1, further comprising:
compressing the data change operations at the data change filter before transmitting the compressed data change operations over the network connection.

6. The method of claim 1, further comprising:
encrypting the data change operations at the data change filter before transmitting the encrypted data change operations over the network connection.

7. The method of claim 1, further comprising directing the replication processing service to:
aggregate the data change operations from the data change filter at a configurable interval before replicating the data change operations.

8. The method of claim 1, wherein the data change operations comprise input/output operations for a virtual storage disk, and each of the input/output operations comprises an offset of the virtual storage disk and binary data.

9. The method of claim 1, wherein the data change operations comprise input/output operations for a virtual storage disk, and the data change filter intercepts the data change operations by asynchronously copying the input/output operations without blocking the input/output operations from proceeding to the virtual storage disk.

10. A device comprising:
a processor; and
a non-transitory computer readable medium storing instructions which, when executed by the processor, cause the processor to:
configure a data change filter in a hypervisor of a virtualization host, the hypervisor configured to execute a virtual machine, the data change filter configured to intercept data change operations from the virtual machine; and
configure a replication processing service on a replication host, the replication host being different from the virtualization host, the replication host and the virtualization host located at an active site, the replication processing service configured to receive the data change operations from the data change filter over a network connection and to replicate the data change operations to a backup site.

11. The device of claim 10, wherein the network connection is established using a TCP/IP-based protocol and the data change filter is configured to encrypt and compress the data change operations before sending the data change operations to the replication processing service.

12. A system comprising:
a first replication host located at an active site; and
a first virtualization host located at the active site, the first virtualization host being different from the first replication host, the first virtualization host being connected to the first replication host by a first network connection, the first virtualization host configured to:
execute a first virtual machine on a first hypervisor;
intercept first data change operations from the first virtual machine using a first data change filter of the first hypervisor; and
send the first data change operations to the first replication host over the first network connection.

13. The system of claim 12, further comprising:
a second replication host located at the active site, the first virtualization host being connected to the second replication host by a second network connection,
wherein the first virtualization host is further configured to intercept second data change operations from the first virtual machine using the first data change filter and send the second data change operations to the second replication host over the second network connection.

14. The system of claim 12, further comprising:
a second virtualization host located at the active site, the second virtualization host being connected to the first replication host by a second network connection, the second virtualization host configured to:
execute a second virtual machine on a second hypervisor;
intercept second data change operations from the second virtual machine using a second data change filter of the second hypervisor; and
send the second data change operations to the first replication host over the second network connection.

15. The system of claim 12, further comprising:
a second replication host located at a backup site, the backup site different from the active site,
wherein the first replication host is configured to replicate the first data change operations to the second replication host.

16. The system of claim 15, further comprising:
a second virtualization host located at the backup site, the second virtualization host being different from the second replication host, the second virtualization host configured to execute a second virtual machine on a second hypervisor, the second replication host configured to rebuild a storage disk for the second virtual machine using the first data change operations.

17. The system of claim 16, wherein a second data change filter of the second hypervisor is configured to provide data to the second virtual machine while the storage disk is rebuilt.

18. The system of claim 15, further comprising:
a data store located at the backup site,
wherein the second replication host is configured to journal the first data change operations on the data store.

19. The system of claim 12, wherein the first virtualization host is further configured to compress the first data change operations before sending the first data change operations to the first replication host over the first network connection.

20. The system of claim 12, wherein the first virtualization host is further configured to encrypt the first data change operations before sending the first data change operations to the first replication host over the first network connection.
